(19) United States
(12) Patent Application Publication
(10) Pub. No.: US 2021/0389151 A1
(43) Pub. Date: Dec. 16, 2021

(54) MICROMOBILITY NAVIGATION SYSTEM WITH INTEGRATED RESPONSIVENESS TO USER DEMOGRAPHIC DATA

(71) Applicant: Megan Marie Braley, Boston, MA (US)

(72) Inventor: Megan Marie Braley, Boston, MA (US)

(21) Appl. No.: 17/342,852

(22) Filed: Jun. 9, 2021

Related U.S. Application Data
(60) Provisional application No. 63/038,782, filed on Jun. 13, 2020.

(51) Int. Cl. G01C 21/36; G01C 21/34; G01S 19/42; G06Q 30/02

(52) U.S. Cl. CPC G01C 21/3626; G01C 21/3664; G06Q 30/0266; G01C 21/3691; G01S 19/42; G01C 21/3484

(57) ABSTRACT

A micro-mobility navigation system with integrated responsiveness to user demographic data. The system includes a central processing unit, a plurality of memory units, input and output devices and a GPS receiver. The navigation route and various content is delivered to the user during navigation of the route based on a user profile.

### CROSS-REFERENCE TO RELATED APPLICATION

This application claims priority to provisional application Ser. No. 63/038,782 filed on Jun. 13, 2020 and entitled “A Micro-mobility Navigation System with Integrated Responsiveness to User Demographic Data.” Said application is incorporated herein by reference.

### TECHNICAL FIELD

The present invention generally relates to the field of travel and mobility and more particularly, is directed to a micro-mobility navigation system with integrated responsiveness to user demographic data.

### BACKGROUND OF THE INVENTION

Micro-mobility encompasses all small, fully or partially human-powered vehicles such as bikes, e-bikes, motor-scooters, e-scooters, electric skateboards and the like. Such devices are often used to travel shorter distances around cities and in many cases help solve the first mile/last mile problem.

Many urban areas rely on mass or public transportation systems to move large numbers of people using group travel technologies such as buses, trolleys and trains. Such systems offer many benefits with respect to, for example, the reduced impact on the environment and a more economical approach to transportation needs.

However, even the best planned and integrated transportation systems cannot fully meet everyone's transportation needs due to the wide variety of dispersed locations where people live, work and are entertained.

Cost, traffic congestion, environmental impact concerns and the scarcity of parking locations typically mean that mass transportations systems can only be relied upon to carry passengers most of the way, leaving first and last miles of passage to other systems. Thus, the first mile/last mile problem discourages many from using mass transportation systems.

In addition, climate and human events often limit the availability and use of normal public transportation systems. For example, extreme weather such as tornadoes and hurricanes can severely impact the operation of such systems for large periods of time. The emergence of a local or world event can lead to avoidance of large gatherings of people and thus less reliance on public transportations systems.

Governments and city planners are cognizant of the need for supplemental means of personalized transportation, and in recent years, huge strides have been made to safely accommodate them on public roads and thoroughfares. Lane sharing systems to accommodate micro-mobility devices have been implemented in many urban areas and many more are being planned in order to accommodate the influx of micro-mobility riders.

In some cases, the increased accommodation for micro-mobility devices and other alternative transportation systems results in the closure of some streets to traditional traffic. Such street closures also allow the recovered space to be used for other purposes, such as outdoor seating for street-adjacent restaurants and other recreational activities. These additional uses are facilitated by the slow-moving nature of micro-mobility devices which allows them to be used much closer to pedestrians than traditional transportations systems, such as cars, trucks and buses.

It is estimated that the micro-mobility market in the U.S. has the potential to reach $200 to $300 Billion by the year 2030. The global market, just in electric scooters alone, is expected to reach $22.1 Billion by the year 2025.

Unlike cars, trucks and buses, micro-mobility devices do not afford the rider much physical protection from road hazards. In addition, these types of devices move at relatively low speeds, usually less than 35 mph, and thus cannot easily escape road hazards quickly when they are spotted.

Thus, there is a need in the art for a method and apparatus that improves the use, utility and safety of micro-mobility devices. The present invention meets this need.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 block diagram of one embodiment of the present invention;

FIG. 2 is a flow chart of one embodiment of a subscriber registration procedure in accordance with the present invention;

FIG. 3 is a flow chart of one embodiment of a goods and services provider registration procedure in accordance with the present invention;

FIG. 4 is a flow chart illustrating the overall operation of the present invention; and

FIG. 5 is a block diagram of a further embodiment of the present invention.

### DESCRIPTION OF THE PREFERRED EMBODIMENT

An example embodiment of the present invention will now be described with reference to the accompanying drawings.

In accordance with the present invention, a micro-mobility device navigation system is provided.

Such a system allows for a more efficient use of micro-mobility devices by plotting the most direct and surest route from a starting point to a desired termination point. Such routing limits the duration of a rider's exposure to road and other hazards along the way, thus making the micro-mobility device a safer travel option. Other benefits are realized as well, including reduced cost of use.

The system of the present invention also allows a user to make a route selection based on the user's preferences. For example, the user may wish to limit the selected route to those having a particular speed limit range, routes having relatively hilly or relatively flat travel surfaces, routes that are busy with other riders or light with other riders, and routes that utilize bike lanes or bike paths. This is not intended to be an exhaustive list of possible preferences that the system of the invention might provide to the user.

Access to many micro-mobility devices is through rental fees based on duration of use. This is especially the case with respect to electric scooters and bicycles. Efficient travel routing lessens the time that the device needs to be used and thus its rental cost.

A further benefit of the system of the present invention is that because of its ability to make intelligent travel route selections, with knowledge of the speed limit requirements of each route and the ability to determine the real time speed of the user, the user is less likely to receive citations and fines for violating traffic laws and regulations.

In addition to efficiency and cost, the navigation system of the present invention makes other safety related improvements in the use of micro-mobility devices as shall be explained below.

As also explained below, the personalized nature of micro-mobility devices is used to provide subscribers of the system with an enhanced travel experience by being responsive to the demographic data profile of the user.

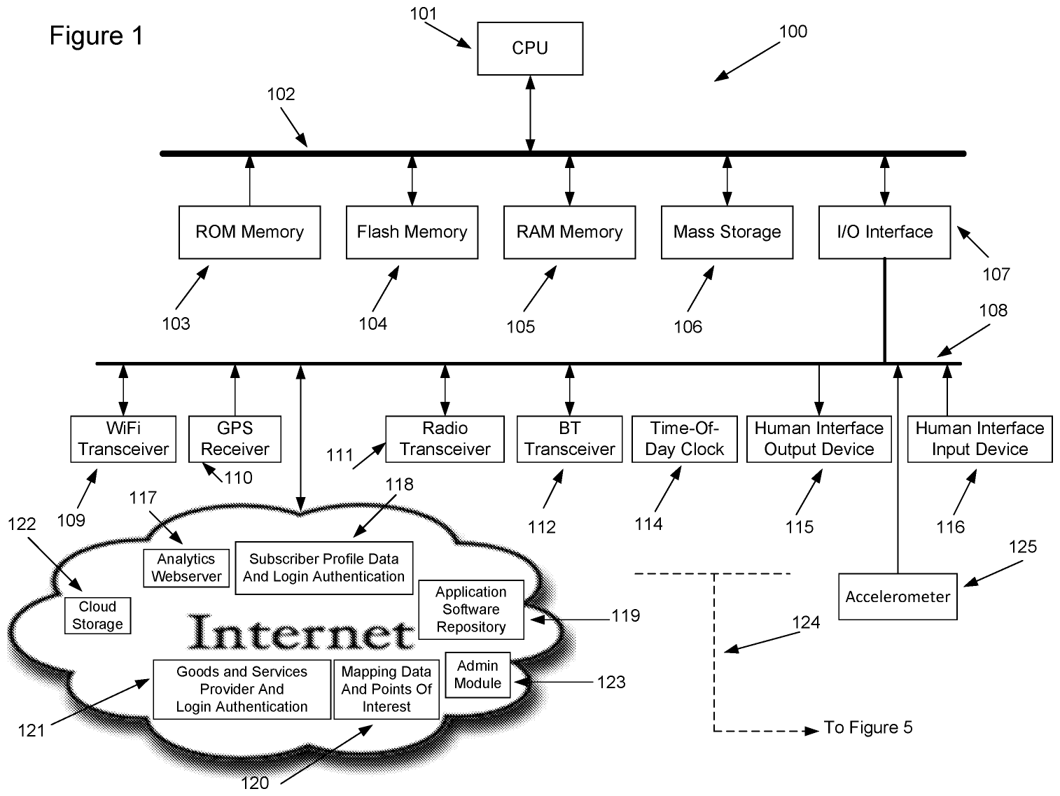

FIG. 1 is an overall block diagram of a navigation system 100 according to one embodiment of the present invention.

As shown in FIG. 1, the system includes Central Processing Unit (CPU) 101 which is used to execute computer software instructions as is known in the art. CPU 101 is coupled, via bus 102, to ROM Memory 103, Flash Memory 104, RAM Memory 105, Mass Storage 106 and I/O Interface 107.

ROM Memory 103 and Flash Memory 104 may be used to store computer software instructions for execution by CPU 101.

RAM memory 105 may also be used for storing computer software instructions, and especially for storing information that is only needed for a short period of time. Mass Storage 106 is used for longer and larger data storage needs as may be required to retain subscriber data over time.

I/O Interface 107 allows the system of the present invention to communicate via bus 108 to other parts of the system, such as Wi-Fi Transceiver 109, GPS Receiver 110, Radio Transceiver 111, Bluetooth Transceiver 112, Time-Of-Day Clock 114, Human Interface Output Device 115 and Human Interface Input Device 116 as discussed below.

The present invention includes a number of other elements which might reside on the Internet as will be discussed below.

The underlying firmware or software which CPU 101 executes may be updated from time to time in order to correct programming errors or to add additional features to the system. Such upgrades can be accomplished by electronic transfer from Application Software Repository 119 which might reside on the Internet.

The hardware aspects of the present invention can be practiced on a smartphone device, tablet computer, laptop or other similar portable devices using Android, iOS or a Windows platform.

For example, such devices typically include the parts of the present invention that are indicated by reference numbers 101-116 as shown in FIG. 1.

Human Interface Output Device 115 and Human Interface Input Device 116 permit a subscriber to interface with the system and correspond to the touch display screen and speaker/microphone systems usually found in such devices. In the case of a smartphone device, Radio Transceiver 111 also corresponds to the cellular radio transceiver.

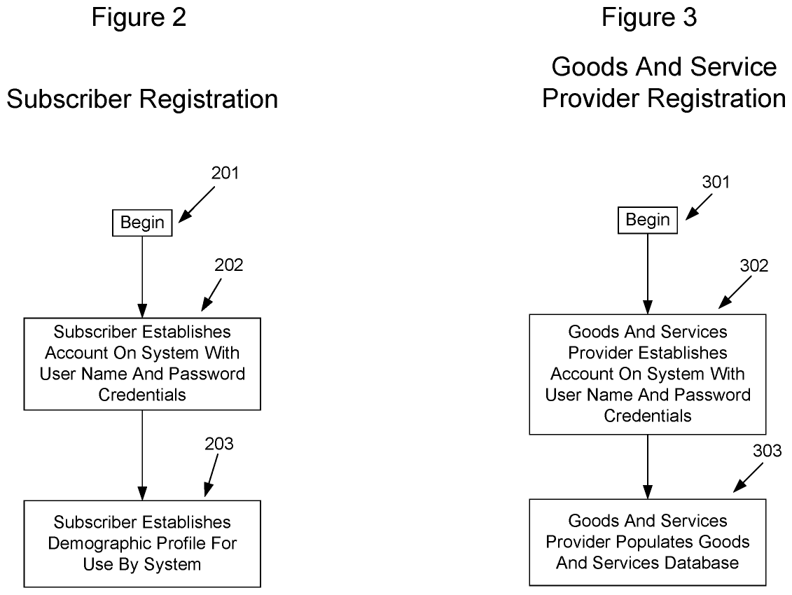

FIG. 2 is a high-level flow chart which illustrates the process of a subscriber registering an account with the system. The registration process begins in Block 201 and moves to Block 202 where the subscriber establishes an account with a user name and password.

In block 203, the subscriber enters certain demographic data such as age, gender, education, race, food and entertainment preferences and the like. Such data allows the system to customize the delivery of advertising and other messages to the subscriber while the system is being used.

The subscriber information can be stored locally on the mobile device or in Cloud Storage 122 shown in FIG. 1. It may also be stored in, and the login function administrated by, Subscriber Profile Data and Login Authentication block 118 shown in FIG. 1.

FIG. 3 is a high-level flow chart which illustrates the process of a provider of goods and services registering an account with the system. The registration process begins in Block 301 and moves to Block 302 where the provider establishes an account with a user name and password.

In block 303, the provider enters information related to its goods and services which it wishes to promote to the subscribers of the system.

The provider information can be stored in Cloud Storage 122 shown in FIG. 1. It may also be stored in, and the login function administrated by, Goods and Services Provider and Login Authentication block 121 shown in FIG. 1.

In accordance with the present invention, it is the subscriber demographic data that the system uses to determine which of the provider information is delivered to the subscriber.

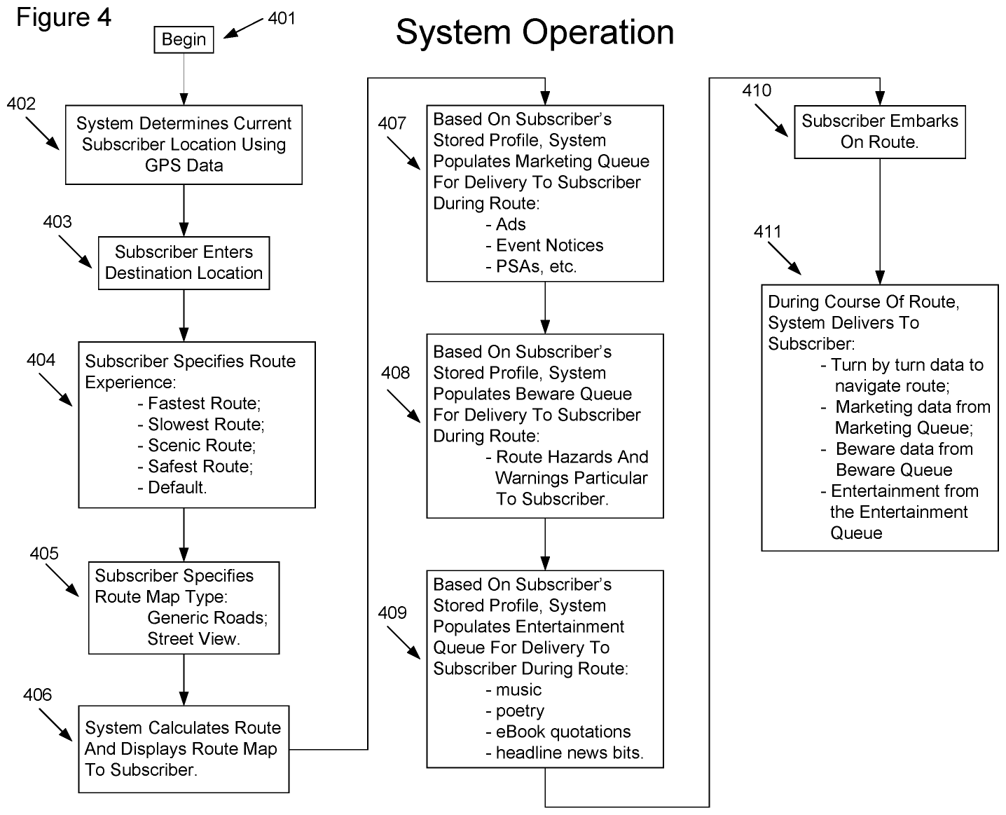

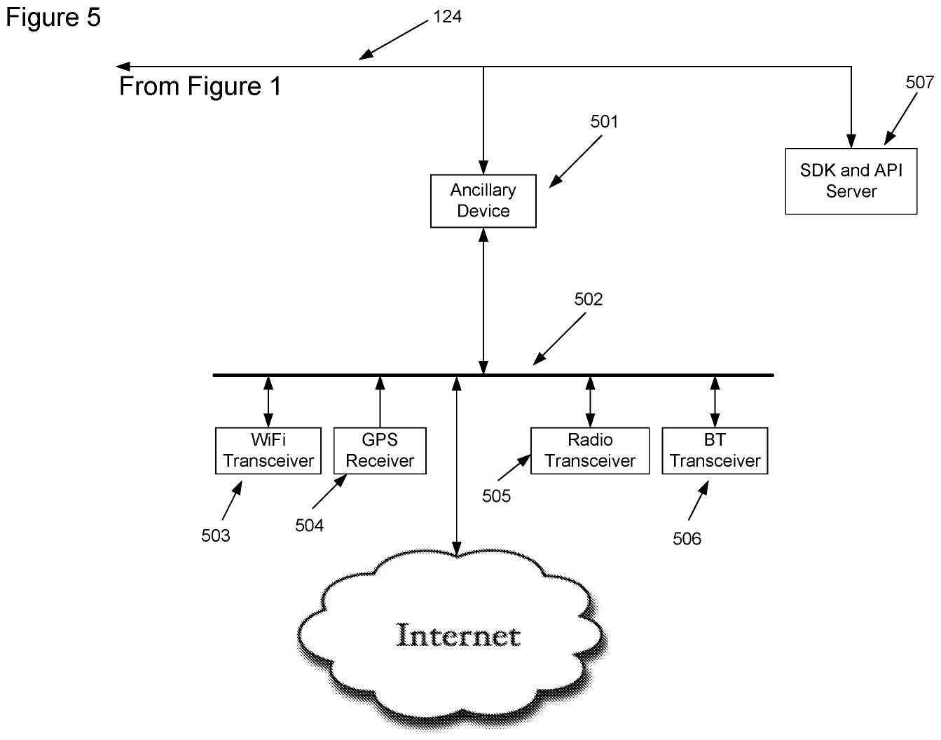

FIG. 4 is a flow chart of the overall operation of the present invention using a smartphone as a hardware base and with reference to FIG. 1.

The operation of the system begins at Block 401 where the subscriber is ready to embark upon a route.

In Block 402, the system determines the subscriber's current location using GPS Receiver 110 and in Block 403, the subscriber enters into the system using, for example the touch screen on smart phone, i.e., Human Interface Input Device 116.

In Block 404, the subscriber selects the type of route experience he/she wishes to have. For example, the fastest route versus the slowest route. Other routes may also be selected, such as a scenic or safest route. Using the time of day obtained from time-of-day clock 114, or a similar clock on the Internet, known or expected traffic patterns and congestion at the particular time of day, and crime patterns and locations, the system can take into account these factors when determining the safest route if that option is selected.

If the particular area has designated travel lanes for micro-mobility devices, the system takes that into account as well when determining the safest route. Crowd sourced information and road ratings based on whether a particular route is micro-mobility device friendly may also be taken into consideration.

In Block 405, the subscriber can select the type of map to be used for the route. For example, a generic map might only display basis road patterns while a street view map would display a realistic view of roads along with ancillary structures such as buildings and trees.

In Block 406, the system calculates the route and displays the route to the subscriber.

Based on the subscriber's stored profile, in Block 407 the system populates a Marketing Queue with advertising material, event notices, public service announcements and the like that are customized to the specific subscriber's profile based on the subscriber's stored demographic data and real-time location.

For example, if the subscriber profile indicates that the subscriber is female and has an interest in sportswear, advertising materials specific to that and other interests would be among the materials placed in the Marketing Queue.

The material placed in the Marketing Queue is also responsive to the time of day. For example, if the trip will occur during or near the noon hour, the advertisements placed in the Market Queue would include lunch time restaurants and the like based on the subscribers expressed food preferences.

The marketing material placed in the Marketing Queue may also include purchase and rental information related to where micro-mobility devices may be obtained or serviced.

Similarly, in Block 408 the system populates a Beware Queue with known route hazards and warnings. If at or near a school zone, appropriate warnings would be entered into the Beware Queue along with other relevant information such as information regarding no scooting zones.

In Block 409, the system populates an Entertainment Queue with such things, as for example, preferred music, poetry, eBook quotations and headline news bits.

In Block 410, the subscriber embarks on the route and in Block 411 during the course of the route, the system distributes to the subscriber the turn-by-turn navigation information need for the subscriber to navigate the route, as well as advertisements, information and other data from the Marketing Queue, beware data from the Beware Queue and entertainment from the Entertainment Queue.

In order to carry out the above invention, it is not necessary that a subscriber avail himself or herself of all of the options illustrated in FIG. 4. Moreover, a base set of options can be set at the time the subscriber registers and those options persist and need not be re-entered from one trip to the next but can be modified or changed when the subscriber desires.

In accordance with the present invention, an Analytics Webserver 117 is provided which can be used to monitor and report on all aspects of system operation. The server may also provide various trends of interest. Admin Module 123 shown in FIG. 1 is used to administer the operation of the system.

As also shown in FIG. 1, the device of the present invention includes an Accelerometer 125.

As known in the art, an accelerometer is a device that is used to measure acceleration forces. Acceleration is the measurement of the change in velocity, or speed divided by time.

As used in the present invention, an unexpected or rapid change in acceleration can indicate that the rider of a micro-mobility device has experienced an unplanned event, such as an accident or the rider having fallen off of the device for some other reason.

In accordance with the present invention, CPU 101, having sensed the event via Accelerometer 125, can then cause the sending of one or more predetermined messages via Wi-Fi Transceiver 109, Radio Transceiver 111 or Bluetooth Transceiver 112 to a destination(s) which the rider has entered into his/her system profile or to a default location such a 911 emergency call center.

CPU 101 may also cause an alert message, such as “Are you ok?”, to be displayed on a display screen for the rider to acknowledge his or her condition. The alert message may also be in the form of an audio alert and the rider's response, or absence of a response may also be in an audio form. The system of invention can then take further action depending upon the rider's response.

FIG. 5 illustrates a further embodiment of the present invention. In accordance with this embodiment, the present invention as described with respect to FIGS. 1-4 may be integrated in whole or in part with an Ancillary Device 501 as shown in FIG. 5. Note Dashed Line 124 in FIG. 1 and its continuation in FIG. 5 to Ancillary Device 501. Correspondingly, the Ancillary Device 501 may also be integrated in whole or in part with the present invention.

As further shown in FIG. 5, Ancillary Device 501 may include a number of devices for facilitating integration of the present invention, for example Wi-Fi Transceiver 503, GPS Receiver 504, Radio Transceiver 506 and Bluetooth Transceiver 506, all of which correspond with their respective counterparts as illustrated in FIG. 1.

Such integration of functionality allows both the invention and the Ancillary Device 501 to achieve the synergistic benefits of their combination.

FIG. 5 also illustrates software development kit (SDK) and application programming interface (API) on server 507. As known in the art, an SDK is a set of software tools, libraries, code samples, etc., that allow software developers to more easily create and manage software on a specific software platform. An API serves as an intermediary that allows two applications to communicate and interface with either other. In accordance with the present invention, the SDK and API residing on server 507 allows software developers to tap into the functions of CPU 101 shown in FIG. 1 in order to add customized functionality to the system of the invention. The SDK and API residing on server 507 is by way of example only and their deployment is not limited thereto.

As pointed out above, Governments and city planners are aware of the need for personalized transportation and have begun to accommodate micro-mobility riders in a safer manner on public roads and thoroughfares. Accordingly, cites, towns and the like now publish micro-mobility use guidelines. More and more of these guide lines are being offered online. The present invention takes advantage of the online availably of such guidelines through the Internet connection shown in FIG. 1. The invention can automatically down the guide lines and electronically implement them when plotting a navigation route and executing navigation along the route, thus bringing the user into automatic compliance with the guidelines.

While the foregoing specification teaches the principles of the present invention, with examples provided for the purpose of illustration, it will be appreciated by one skilled in the art from reading this disclosure that various changes in form and detail can be made without departing from the true scope of the invention.

I claim:

1. A computer implemented navigation system, said system comprising:
a central processing unit (CPU);
a first memory unit coupled to said CPU for storing a computer program for execution by said CPU;
a display device coupled to said CPU for displaying at least one navigation map and for communicating system information to the user;
a GPS receive coupled to said CPU, said CPU using said GPS receiver to determine user location;
a second memory unit coupled to said CPU for storing a user profile for the user;
an input device coupled to said CPU and adapted to allow a user of said system to enter commands to said system and a destination location for said system to navigate to; and
wherein when commanded to do by the user, said CPU executes said computer program to display on said display device at least one CPU generated route from said user location to said destination location and autonomously navigate the user to said designation in accordance with said user profile.

2. The system of claim 1, further comprising:
A login system coupled to said CPU for allowing a user to login into said navigation system; and
a remotely located database for storing a plurality of user profiles for different users of said system, wherein when a user logs into said navigation system using said login system, said CPU executes said software program to retrieve from said database the stored user profile for that user and stores said profile in said second memory unit.

3. The system of claim 1, further comprising:
a third memory unit coupled to said CPU for storing a plurality of said routes selected from the group consisting of fastest route, slowest routed, scenic route and safest route;
wherein the user selecting a desired route to be following using said input device.

4. The system of claim 1, further comprising:
a fourth memory unit coupled to said CPU for storing a plurality of said navigation maps selected from the group consisting of a generic road map and a street view map, using said input device the user selecting a desired navigation map to be used.

5. The system of claim 1, further comprising:
a marketing queue coupled to said CPU for storing a plurality of marketing content to be displayed to the user while the user is navigating said route, said marketing content being selected from the group consisting of advertisements, event notices and public service announcements.

6. The system of claim 1, further comprising:
a road warning queue coupled to said CPU for storing a plurality of warning to be displayed to the user while the user is navigating said route, said warnings being selected from the group consisting of route hazards and warning that are particular to the user.

7. The system of claim 1, further comprising:
an entertainment queue coupled to said CPU for storing a plurality of entertainment content to be presented to the user while the user is navigating said route, said entertainment content being selected from the group consisting of music, poetry, eBook quotations and headline news bits.

8. The system of claim 1, further comprising:
a communications device adapted for communicating a user's status a remote location.

9. The system of claim 8, further comprising:
an accelerometer device coupled to said CPU, said accelerometer device being adapted for determining a use's real time speed of movement and an anomaly indicated by an abrupt change in real time speed or plane of movement, said CPU causing said anomaly to be communicated to said remote location using said communications device.

10. The system of claim 1, wherein said input device is adapted to allow a user of said system to customize said route.

11. The system of claim 10, wherein said customization is selected from the group consisting of maximum travel speed, bike lane route, bike path route, and road density.

12. The system of claim 1, further comprising:
a software development server for hosting software development tools for said system.

13. A method for implementing a navigation system, said method consisting of the steps of:
providing a central processing unit (CPU);
coupling a first memory unit to said CPU and using said memory unit for storing a computer program for execution by said CPU;
coupling a display device to said CPU and using said display device to display at least one navigation map and to communicate system information to the user;
coupling a GPS receiver to said CPU and using said GPS receiver to determine the location of the user;
coupling a second memory unit to said CPU and using said second memory unit to store a user profile for the user;
coupling an input device to said CPU and using said input device for the user of said system to enter commands to said system and entering a destination location for said system to navigate to; and
wherein when commanded to do by the user, said CPU executing said computer program to display on said display device at least one CPU generated route from said user location to said destination location and autonomously navigating the user to said designation in accordance with said user profile.

14. The method of claim 13, further including the steps of:
coupling a login system to said CPU and using said login system for the user to login into said navigation system; and
coupling a remotely located database to said CPU and using said database to store a plurality of user profiles for different users of said system, wherein when a user logs into said navigation system using said login system, said CPU executes said software program to retrieve from said database the stored user profile for that user and stores said profile in said second memory unit.

15. The method of claim 13, further including the steps of:
coupling a third memory unit to said CPU and using said third memory unit to store a plurality of said routes selected from the group consisting of fastest route, slowest routed, scenic route and safest route; and
wherein the user selecting a desired route to be following using said input device.

16. The method of claim 13, further including the step of:
coupling a fourth memory unit to said CPU and using said fourth memory unit store a plurality of said navigation maps selected from the group consisting of a generic road map and a street view map; and
using said input device the user selecting a desired navigation map to be used.

17. The method of claim 13, further including the step of:
coupling a marketing queue to said CPU and using said marketing queue to store a plurality of marketing content to be displayed to the user while the user is navigating said route, said marketing content being selected from the group consisting of advertisements, event notices and public service announcements.

18. The method of claim 13, further including the step of:
coupling a road warning queue to said CPU and using said road warning queue to store a plurality of warning to be displayed to the user while the user is navigating said route, said warnings being selected from the group consisting of route hazards and warning that are particular to the user.

19. The method of claim 13, further including the step of:
coupling an entertainment queue to said CPU and using said entertainment queue to store a plurality of entertainment content to be presented to the user while the user is navigating said route, said entertainment content being selected from the group consisting of music, poetry, eBook quotations and headline news bits.

20. The method of claim 13, further including the step of:
coupling a communications device to said CUP and using said communications device to communicate the user's status to a remote location;
coupling an accelerometer device to said CPU and using said accelerometer device to determine the use's real time speed of movement and an anomaly indicated by an abrupt change in real time speed or plane of movement; and
using said communications device to communicate said anomaly to said remote location.
